(19) United States
(12) Patent Application Publication
(10) Pub. No.: US 2002/0189752 A1
(43) Pub. Date: Dec. 19, 2002

(54) Air cushion film laminate and method of making same

(76) Inventor: Thomas D. Wetsch, St. Charles, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/880,363

(22) Filed: Jun. 13, 2001

(51) Int. Cl. B32B 3/00

(52) U.S. Cl. 156/291; 428/156; 156/145; 156/292

(57) ABSTRACT

A multiple layer polyethylene laminated film in which the outer layer is a polyethylene film and the inner layer is a polyethylene air cushioned film. A heated pressure sensitive adhesive comprising synthetic rubber is applied to one or both of the inner surfaces of the outer film and the air cushioned film to secure the two to each other.

### BACKGROUND OF THE INVENTION

The present invention relates to cushioned mailing envelopes and, more particularly, to an improved laminate material for use in making cushioned mailing envelopes and a method for making the laminate.

Air bubble mailers are popular because they are lightweight and low cost. However, they are not particularly durable, and cannot be easily recycled. Further, the paper material tears easily when the envelope is loaded with its contents and shipped through the small parcel system. This results in a high level of complaints due to damage, returns, and lost products in the system.

Most cushioned envelopes are made by laminating bubble film to poly-coated paper, the paper forming the outer surface of the envelope. Typically, when laminated to bubble film, the bubble tips are laminated to the paper, with the “smooth” or non-embossed surface of the bubble film being used for the inside of the envelope in order to facilitate easy loading of the contents. When the two materials are laminated, the poly-coated paper is heated to accept the bubble film for a full contact bond. Poly-coated paper is used as a laminate because it is stable, is not temperature sensitive, and allows the bubble film to adhere to the paper without any changes to either substrate.

Attempts have been made to simply replace the outer paper layer with polyethylene (PE) film to make a stronger, more easily recyclable envelope. However, up to the present time laminating PE film to bubble wrap has required the use of heat, or heat and pressure. This presents numerous difficulties, as the physical and aesthetic properties of the PE film change when subjected to heat. This is because PE film is typically manufactured using a blown film process that stretches the film under heat, and then cools the material under stress, giving the film orientation. This orientation is relieved if the film is reheated when attempting to bond the film to other materials. The use of heat on PE film can also cause the film to shrink, stretch and deform. In addition, the use of heat introduces aesthetic imperfections in what will be the outer surface of the envelope, which is not desirable.

Bubble material is typically made from two 1.5 mil polyethylene film layers making up the top and the bottom layer, with air entrapped between the layers. The top of the bubble material thins down to 0.5 mil. in the process of molding the bubble or embossed side. Because the bubble side becomes so thin, it is difficult to heat or laminate any other plastic material to the bubble and maintain integrity of the bubble material or the outer film. The bubble must also be bonded to film without the use of heat, which causes the bubbles to deflate and deform, thus losing integrity and functionality. Thus, both the inner bubble film and the outer film are temperature sensitive, making it difficult to use hot adhesives and/or heat to create a bond between the two layers.

To adhere the bubble material to another film requires the introduction of an adhesive that is cool, tacky, and sets up quickly. However, cold adhesives have their own limitations. Cold adhesives require excessive dry times, which make it economically unfeasible for use in film combinations.

Accordingly, it is the principal object of the present invention to provide a two-layer air cushion film laminate of bubble wrap and a plastic film and a method for making such a laminate.

### SUMMARY OF THE INVENTION

This object, as well as others which will become apparent upon reference to the following detailed description and accompanying drawing, are provided by a multiple layer laminated film in which the outer layer is a plastic film, such as polyethylene, polyester or polypropylene film, and the inner layer is an air cushion film. A heated, pressure-sensitive adhesive comprising synthetic rubber is applied by spraying to one or both of the inner surfaces of the outer film and the air cushion film to secure the two to each other.

Preferably, the air cushion film comprises a bubble film with a first polyethylene sheet with an embossed side having a plurality of raised cells and an unembossed side. A second polyethylene backing sheet is laminated to the unembossed side to seal the cells. The heated, pressure-sensitive adhesive is then applied by spraying it onto either or both inner surfaces of the outer film and the embossed side of the air cushioned film. Additionally, the inner surface of the outer film may advantageously include a metallocene catalyst, and the outer surface of the film may include a pigment and a filler to give the material a paper-like feel.

In order to manufacture such a multi layer film, the outer plastic film is provided and air cushioned film is provided. A heated, pressure-sensitive adhesive comprising synthetic rubbers is applied by spraying to one, or both, of the inner surface of the outer film and the embossed side of the air cushioned film. The two films are than fed through the nip of a pair of rollers to secure them to each other.

### BRIEF DESCRIPTION OF THE DRAWING

FIG. 1 is a schematic view showing the manufacture of an air cushion film laminate in accordance with the present invention.

### DETAILED DESCRIPTION OF THE PREFERRED EMBODIMENT

In accordance with the present invention, two layers of material are combined to create a lightweight, recyclable cushioned mailer. A bubble film material used as the cushion is combined with a layer of flat plastic film, such as polyethylene, polypropylene or polyester. Both the flat film and the bubble film are commercially available products made by methods well known in the art and are typically available in rolls. Once these two layers are laminated together, they can then be heat sealed into various sized, recyclable, cushioned envelopes, also using well-known envelope fabrication methods.

The outer layer of flat film is preferably a mixed or co-extruded LDPE/HDPE-recycled LDPE material of 1 to 8 mils in thickness. Alternatively, the outer layer may be a spun bound polyolefin, such as the Tyvek film available from DuPont. The inner surface includes metallocene for sealing, while the outer surface contains a colorant (usually white) and additional fillers to give the material a paper-like feel.

The bubble film is preferably made from a co-extruded LDPE/nylon/LDPE or, optionally LDPE/LDPE. A first layer of thin film is embossed to create a series of raised cells or bubbles on the embossed side of the film. A layer of flat thin film is then laminated to the unembossed side of the bubble film to create a cellular air-filled cushioning material that is very lightweight.

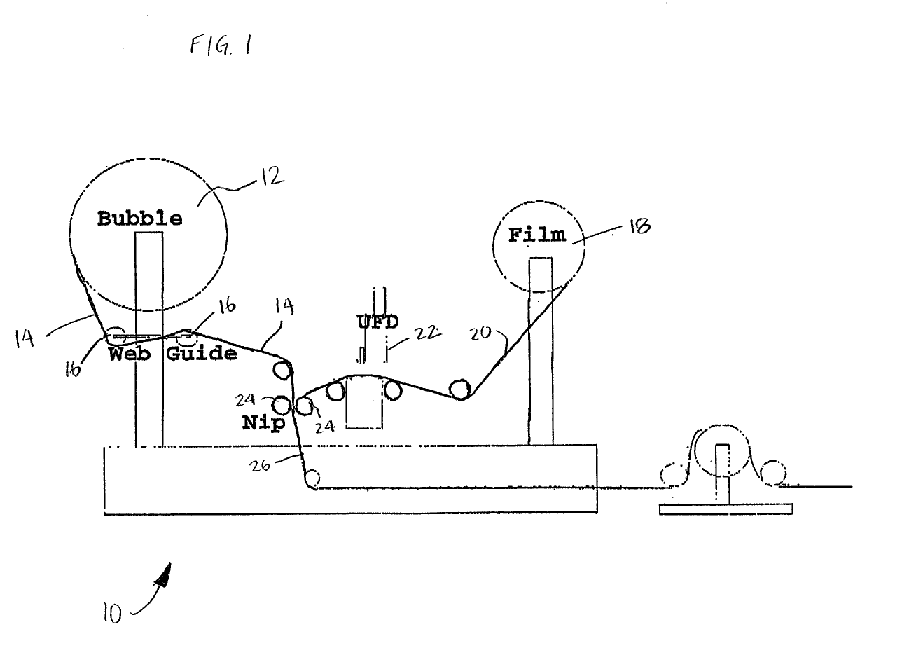

With reference to FIG. 1, an apparatus, generally designated 10, is shown that is adapted to manufacture the air cushion film laminate of the present invention. A roll 12 of bubble film material is mounted so that the roll feeds a web of bubble film 14 from the roll through a pair of rollers 16 that form a web guide for maintaining the alignment of the bubble film. A roll of flat film is mounted opposite the bubble film roll 12 so that a web of flat film 20 is fed from the roll 18. The webs 14, 20 are generally the same width, the width being a matter of operator choice.

In accordance with the present invention, a hot, pressure sensitive adhesive is used which is fiberized and, due to it being sprayed, is sufficiently cooled prior to contacting the substrates to avoid damage to the films being laminated together. A synthetic, fiberized, rubber-based pressure sensitive adhesive (PSA), such as 37-600 series PSAs made by Sovereign Engineered Adhesives and the HAS-H2345 PSAs by Heigl Adhesives of Eden Prairie, Minn., have been found to provide an aggressive tack, indefinite open time, and excellent adhesion. The preheated, fiberized, pressure-sensitive adhesive material cools by using pressurized air streams to spray the adhesive.

Again with reference to FIG. 1, the adhesive is applied to the flat film 20 by a spray applicator 22. The applicator 22 preferably comprises a plurality of spray heads, each capable of being individually controlled by, e.g., a solenoid, to create a air stream. The air streams are pulsed to individually vary the streams of pressure sensitive adhesive, which is extruded hot, from individual ports or nozzles. An adhesive application system providing such features is available variously from Nordson Corporation of Duluth, Georgia, ASI of Auburn, Ga., and ITW Dynatec of Hendersonville, Tenn. The pulsed air streams create a randomized pattern of adhesive between the bubble tops and the inner surface of the outer layer of flat film. While the application temperature of the adhesive is between 300-350° F., by the time the adhesive contacts the film, it has cooled between approximately 100°-130° F., and preferably no higher than 110° F.

The bank of spray heads is moveable so that the distance between the nozzles of the applicators and the surface of the flat film 20 may be varied between ½ inch and 12 inches. Preferably the distance between the nozzles and the film is between 3 inches and 6 inches. This is adjustable to fine tune the process and apply the adhesive at the proper temperature. Opposite the nozzles, on the other side of the film 20, a box collector 24 may be provided that has a slot therein for capturing any over sprayed adhesive. The randomized adhesive pattern may alternatively be applied to the tips of the bubbles, with a minimal amount of adhesive being also applied to the inside of the outer film and the tips of the bubbles.

After the adhesive is applied to the flat film 20, the two webs 14, 20 are fed through a nip of a pair of rollers 24 to join the two webs to each other and form the laminate 26. Preferably, the web 14 of the bubble film travels along a substantially straight path directly into the nip so as to insure an even, wrinkle-free contact with the flat film. After the two webs are joined together, the resulting air cushion film laminate 26 may be directly converted into mailing envelopes, or formed into a roll for converting at a later time or different location.

It is desirable to seal the bubble tops to the outer layer of film so that envelopes manufactured from the laminated film can have the smooth side of the bubble material on the inside of the envelope. As noted above, a smooth interior for the envelopes is preferable, as it allows for the easy loading of product into the finished envelope.

Once the two films are adhered to each other to form a laminate 26, the laminate may be fabricated into mailing envelopes in the well known manner. First, the laminate is “V” folded to create a bag, and an adhesive closure is applied to the top edge of the bag. The adhesive closure includes a release strip to protect the adhesive, the release strip being later peeled off by the user to bond the flap of the bag once the contents have been placed in the bag. Next, a mechanical bubble-deflating device is utilized to deflate the bubbles that are located in the seal portion of the bag. If the bubble material is not deflated the envelope edges will not seal. Heat sealers then seal the “V” folded material where the mechanical device has deflated the bubble material. Once the edges of the bag are sealed the material is indexed to the cut off station. The cut off station cuts each bag apart at the center of the heat seal, creating individually padded envelopes.

Thus, a padded film laminate and a padded envelope have been provided that meet all the objects of the present invention. While the invention has been described in terms of a preferred embodiments, there is no intent to limit the invention to the same. Instead, the invention is intended to be defined by the appended claims.

The embodiments of the invention in which an exclusive property or privilege is claimed are defined as follows:

1. A multiple layer laminated film comprising:
an outer plastic film with an inner surface and an outer surface;
a plastic air cushion film; and
a pressure sensitive adhesive comprising heated synthetic rubber applied to one or both of the inner surface of the outer film and the embossed side of the air cushion film to secure the air cushion film to the outer film.

2. The multiple layer film of claim 1 wherein the inner surface of the outer film includes a metallocene catalyst and the outer surface of the outer film includes a pigment and a filler.

3. The multiple layer film of claim 1 wherein the air cushion film comprises a first polyethylene sheet having an embossed side with a plurality of raised cells and an unembossed side, with a second polyethylene backing sheet laminated to the unembossed side of the first sheet to seal the cells

4. A method of making a multilayer polyethylene film comprising:
providing a flat plastic film with an inner surface and an outer surface;
providing an air cushion film;
applying a heated pressure sensitive adhesive comprising synthetic rubber to one or both of the inner surface of the flat film and the embossed side of the air cushion film; and
feeding the flat film and the air cushion film through the nip of a pair of rollers to secure the flat film to the air cushion film.

5. The method of claim 4 wherein the adhesive is applied at a temperature of less than approximately 110° F.

6. The method of claim 4 wherein the inner surface of the flat film includes a metallocene catalyst and the outer surface of the flat film includes a pigment and a filler.

7. The method of claim 4 wherein the air cushion film comprises a first polyethylene sheet having an embossed side with a plurality of raised cells and an unembossed side with, a second polyethylene backing sheet laminated to the unembossed side of the first sheet to seal the cells.
